(19) United States
(12) Patent Application Publication
(10) Pub. No.: US 2020/0387840 A1
(43) Pub. Date: Dec. 10, 2020

(54) INFORMATION PROCESSING DEVICE, INFORMATION PROCESSING METHOD, AND STORAGE MEDIUM

(71) Applicant: HONDA MOTOR CO., LTD., Tokyo (JP)

(72) Inventors: Junpei Noguchi, Wako-shi (JP); Chie Sugihara, Tokyo (JP); Yuta Takada, Tokyo (JP); Ryoma Taguchi, Tokyo (JP)

(21) Appl. No.: 16/866,587

(22) Filed: May 5, 2020

(30) Foreign Application Priority Data
May 15, 2019 (JP) 2019-091964

(51) Int. Cl. G06Q 10/02; G06Q 30/02; G08G 1/14; G08G 1/0967

(52) U.S. Cl. CPC G06Q 10/02; G06Q 30/0284; G08G 1/096725; G08G 1/146; G08G 1/143; G08G 1/148

(57) ABSTRACT

An information processing device includes an acquisition unit that acquires position information of a user of a vehicle parked in a parking lot, and a processing unit that determines whether or not an arrival time of the user at a predetermined position in the parking lot exceeds a reserved time period included in parking reservation information on the basis of the position information of the user, determines whether or not to move the vehicle from a parking position on the basis of a result of the determination as to whether the arrival time exceeds the reserved time period, and performs processing based on a result of the determination as to whether to move the vehicle.

### CROSS-REFERENCE TO RELATED APPLICATION

Priority is claimed on Japanese Patent Application No. 2019-091964, filed May 15, 2019, the content of which is incorporated herein by reference.

### BACKGROUND

### Field of the Invention

The present invention relates to an information processing device, an information processing method, and a storage medium.

### Description of Related Art

A technology relating to reservation management of a parking lot, which determines whether or not a reservation can be accepted when a user has issued a request for the reservation, prompts another user to retrieve a vehicle from the parking lot upon determining that the reservation cannot be accepted, and executes the reservation if the retrieval is agreed, is disclosed in the related art (see, for example, Japanese Unexamined Patent Application, First Publication No. 2012-215923).

### SUMMARY

However, in the technology of the related art, sufficient studies have not been conducted on management of parking times of vehicles as scheduled.

Aspects according to the present invention have been made in view of such circumstances and it is an object of the present invention to provide an information processing device, an information processing method, and a storage medium which can manage parking times of vehicles as scheduled.

To solve the above problem and achieve the relevant object, the present invention provides the following aspects.

(1) An information processing device according to an aspect of the present invention includes an acquisition unit configured to acquire position information of a user of a vehicle parked in a parking lot, and a processing unit configured to determine whether or not an arrival time of the user at a predetermined position in the parking lot exceeds a reserved time period included in parking reservation information on the basis of the position information of the user, determine whether or not to move the vehicle from a parking position on the basis of a result of the determination as to whether the arrival time exceeds the reserved time period, and perform processing based on a result of the determination as to whether to move the vehicle.

(2) The information processing device according to the above aspect (1) may further include a communication unit configured to communicate with a terminal device of the user, wherein the processing unit is configured to transmit information prompting extension of the reserved time period to the terminal device using the communication unit upon determining that the arrival time of the user at the predetermined position in the parking lot exceeds the reserved time period included in the parking reservation information and not to move the vehicle from the parking position when the communication unit has received information requesting extension of the reserved time period from the terminal device.

(3) The information processing device according to the above aspect (1) or (2) may further include a communication unit configured to communicate with a terminal device of the user, wherein the processing unit is configured to transmit information prompting extension of the reserved time period to the terminal device using the communication unit upon determining that the arrival time of the user at the predetermined position in the parking lot exceeds the reserved time period included in the parking reservation information and move the vehicle from the parking position when the communication unit has not received information requesting extension of the reserved time period from the terminal device.

(4) In the information processing device according to the above aspect (3), the processing unit may be configured to receive an operation of driving the vehicle performed by a manager of the parking lot when the communication unit has not received information requesting extension of the reserved time period from the terminal device.

(5) In the information processing device according to the above aspects (2) to (4), the processing unit may be configured not to move the vehicle from the parking position if there is no parking reservation for a time period subsequent to the reserved time period when the communication unit has not received information requesting extension of the reserved time period from the terminal device.

(6) In the information processing device according to the above aspect (5), the processing unit may be configured to calculate a parking fee of the vehicle by applying a penalty fee that is defined for a case where the reserved time period is exceeded in a parking fee table if there is no parking reservation for a time period subsequent to the reserved time period when the communication unit has not received information requesting extension of the reserved time period from the terminal device.

(7) In the information processing device according to the above aspect (6), the parking fee table may be defined such that a parking fee per parking time unit is higher when the reserved time period has not been extended than when the reserved time period has been extended.

(8) In the information processing device according to the above aspects (2) to (7), the processing unit may be configured to move the vehicle from the parking position if there is a parking reservation for a time period subsequent to the reserved time period when the communication unit has not received information requesting extension of the reserved time period from the terminal device.

(9) In the information processing device according to the above aspect (8), the processing unit may be configured to, if there is a parking reservation for a time period subsequent to the reserved time period when the communication unit has not received information requesting extension of the reserved time period from the terminal device, move the vehicle parked in the parking lot from the parking position when a vehicle that has made the parking reservation has entered the parking lot.

(10) In the information processing device according to the above aspects (1) to (9), the processing unit may be configured to set an upper limit of the number of vehicles which are collaterally moved from the parking position and change the upper limit on the basis of information acquired from the terminal device of the user.

(11) In the information processing device according to the above aspect (1) to (10), the information processing device may be configured to function as a parking management device and perform a process of transmitting information instructing movement to the vehicle as a process of moving the vehicle from the parking position.

(12) In the information processing device according to the above aspect (1) to (10), the information processing device may be mounted in a vehicle and configured to perform a process of causing the vehicle to automatically travel as a process of moving the vehicle from the parking position.

(13) An information processing method according to an aspect of the present invention includes acquiring by a computer, position information of a user of a vehicle parked in a parking lot, and determining by the computer, whether or not an arrival time of the user at a predetermined position in the parking lot exceeds a reserved time period included in parking reservation information on the basis of the position information of the user, determining whether or not to move the vehicle from a parking position on the basis of a result of the determination as to whether the arrival time exceeds the reserved time period, and performing processing based on a result of the determination as to whether to move the vehicle.

(14) A non-transitory computer-readable storage medium according to an aspect of the present invention stores a program causing a computer to execute a process of acquiring position information of a user of a vehicle parked in a parking lot, and a process of determining whether or not an arrival time of the user at a predetermined position in the parking lot exceeds a reserved time period included in parking reservation information on the basis of the position information of the user, determining whether or not to move the vehicle from a parking position on the basis of a result of the determination as to whether the arrival time exceeds the reserved time period, and performing processing based on a result of the determination as to whether to move the vehicle.

According to the above aspects (1) to (14), parking times of vehicles can be managed as scheduled.

### BRIEF DESCRIPTION OF THE DRAWINGS

FIG. 1 is a configuration diagram of a vehicle system 1.

FIG. 2 is a functional configuration diagram of a first controller 120 and a second controller 160.

FIG. 3 is a diagram schematically showing a situation in which a self-propelled parking event is executed.

FIG. 4 is a diagram showing an example of a configuration of a parking management device 400.

FIG. 5 is a diagram showing an example of a parking reservation table 444.

FIG. 6 is a diagram showing an example of a parking space state table 446.

FIG. 7 is a diagram showing an example of a determination table 448.

FIG. 8 is a diagram showing an example of a parking fee table 450.

FIG. 9 is a diagram for explaining a flow of processing when the parking management device 400 according to a first embodiment executes a parking reservation.

FIG. 10 is a flowchart showing a flow of a series of processes of the parking management device 400 according to the first embodiment.

FIG. 11 is a diagram for explaining a flow of processing when the parking management device 400 according to a second embodiment executes a parking reservation.

FIG. 12 is a flowchart showing a flow of a series of processes of the parking management device 400 according to the second embodiment.

FIG. 13 is a flowchart showing a flow of a series of processes of the parking management device 400 according to a third embodiment.

FIG. 14 is a configuration diagram of a vehicle system 1 according to a fourth embodiment.

FIG. 15 is a diagram showing an example of a hardware configuration of an automated driving control device 100.

### DETAILED DESCRIPTION OF THE INVENTION

Hereinafter, embodiments of an information processing device, an information processing method, and a storage medium according to the present invention will be described with reference to the drawings. Embodiments in which the information processing device functions as a parking management device and parking management targets of the parking management device are automated driving vehicles will be described below. Automated driving is, for example, automatic control of one or both of steering and acceleration/deceleration of a vehicle to perform driving control of the vehicle. Driving control of an automated driving vehicle may also be performed by a manual operation of a user.

### [Overall Configuration]

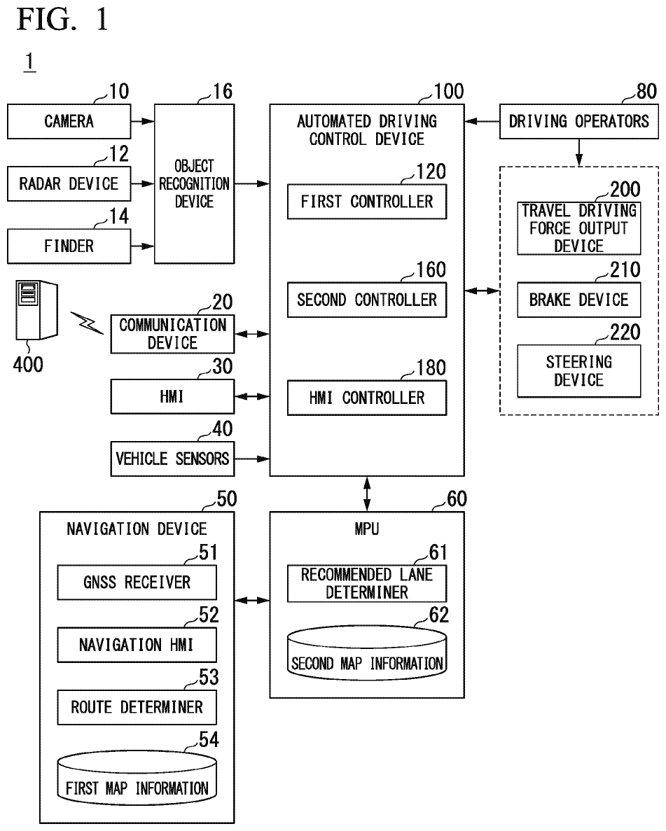

FIG. 1 is a configuration diagram of a vehicle system 1. A vehicle in which the vehicle system 1 is mounted is, for example, a vehicle such as a two-wheeled vehicle, a three-wheeled vehicle, or a four-wheeled vehicle, and a driving source thereof is an internal combustion engine such as a diesel engine, a gasoline engine, or a hydrogen engine, an electric motor, or a combination thereof. The electric motor operates using electric power generated by a generator connected to the internal combustion engine or using discharge power of a battery (storage battery) such as a secondary battery or a fuel cell.

The vehicle system 1 includes, for example, a camera 10, a radar device 12, a finder 14, an object recognition device 16, a communication device 20, a human machine interface (HMI) 30, vehicle sensors 40, a navigation device 50, a map positioning unit (MPU) 60, driving operators 80, an automated driving control device 100, a travel driving force output device 200, a brake device 210, and a steering device 220. These devices or apparatuses are connected to each other by a multiplex communication line or a serial communication line such as a controller area network (CAN) communication line, a wireless communication network, or the like. The components shown in FIG. 1 are merely an example and some of the components may be omitted or other components may be added.

The camera 10 is, for example, a digital camera using a solid-state imaging device such as a charge coupled device (CCD) or a complementary metal oxide semiconductor (CMOS). The camera 10 is attached to the vehicle in which the vehicle system 1 is mounted (hereinafter referred to as a vehicle M) at an arbitrary location. For imaging the area in front of the vehicle, the camera 10 is attached to an upper portion of a front windshield, a rear surface of a rearview mirror, or the like. For example, the camera 10 repeats imaging of the surroundings of the vehicle M at regular intervals. The camera 10 may also be a stereo camera.

The radar device 12 radiates radio waves such as millimeter waves around the vehicle M and detects radio waves reflected by an object (reflected waves) to detect at least the position (distance and orientation) of the object. The radar device 12 is attached to the vehicle M at an arbitrary location. The radar device 12 may detect the position and velocity of an object using a frequency modulated continuous wave (FM-CW) method.

The finder 14 is a light detection and ranging (LIDAR) finder. The finder 14 illuminates the surroundings of the vehicle M with light and measures scattered light. The finder 14 detects the distance to a target on the basis of a period of time from when light is emitted to when light is received. The light radiated is, for example, pulsed laser light. The finder 14 is attached to the vehicle M at an arbitrary location.

The object recognition device 16 performs a sensor fusion process on results of detection by some or all of the camera 10, the radar device 12, and the finder 14 to recognize the position, type, speed, or the like of the object. The object recognition device 16 outputs the recognition result to the automated driving control device 100. The object recognition device 16 may output detection results of the camera 10, the radar device 12, and the finder 14 to the automated driving control device 100 as they are. The object recognition device 16 may be omitted from the vehicle system 1.

For example, the communication device 20 communicates with, for example, other vehicles present near the vehicle M, a parking management device 400, or various server devices using a cellular network, a Wi-Fi network, Bluetooth (registered trademark), dedicated short range communication (DSRC), or the like.

The HMI 30 presents various types of information to the user of the vehicle M and receives an input operation from the user. The HMI 30 includes display devices, a speaker, a buzzer, a touch panel, switches, keys, and the like. The display devices include, for example, a meter display provided at a portion of an instrument panel facing the driver, a center display provided at the center of the instrument panel, and a head-up display (HUD). The HUD is, for example, a device that allows an image to be viewed superimposed on a landscape. In an example, the HUD projects light including an image on a front windshield or a combiner of the vehicle M to allow the user to view a virtual image.

The vehicle sensors 40 include a vehicle speed sensor that detects the speed of the vehicle M, an acceleration sensor that detects the acceleration thereof, a yaw rate sensor that detects an angular speed thereof about the vertical axis, an orientation sensor that detects the orientation of the vehicle M, or the like. The vehicle sensors 40 may further include load sensors that detect loads applied to seats in the passenger compartment. Detection results of the vehicle sensors 40 are output to the automated driving control device 100.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 identifies the position of the vehicle M on the basis of signals received from GNSS satellites. The position of the vehicle M may also be identified or supplemented by an inertial navigation system (INS) using the output of the vehicle sensors 40. The navigation HMI 52 includes a display device, a speaker, a touch panel, a key, or the like. The navigation HMI 52 may be partly or wholly shared with the HMI 30 described above. For example, the route determiner 53 determines a route from the position of the vehicle M identified by the GNSS receiver 51 (or an arbitrary input position) to a destination input by the user using the navigation HMI 52 (hereinafter referred to as an on-map route) by referring to the first map information 54. The first map information 54 is, for example, information representing shapes of roads by links indicating roads and nodes connected by the links. The first map information 54 may include curvatures of roads, point of interest (POI) information, or the like. The on-map route is output to the MPU 60. The navigation device 50 may also perform route guidance using the navigation HMI 52 on the basis of the on-map route. The navigation device 50 may also transmit the current position and the destination to a navigation server via the communication device 20 and acquire a route equivalent to the on-map route from the navigation server. The navigation device 50 outputs the determined on-map route to the MPU 60.

The MPU 60 includes, for example, a recommended lane determiner 61 and holds second map information 62 in a storage device such as an HDD or a flash memory. The recommended lane determiner 61 divides the on-map route provided from the navigation device 50 into a plurality of blocks (for example, into blocks each 100 meters long in the direction in which the vehicle travels) and determines a recommended lane for each block by referring to the second map information 62. The recommended lane determiner 61 determines the number of the lane from the left in which to travel. When there is a branch point on the on-map route, the recommended lane determiner 61 determines a recommended lane such that the vehicle M can travel on a reasonable route for proceeding to the branch destination.

The second map information 62 is map information with higher accuracy than the first map information 54. The second map information 62 includes, for example, information of the centers of lanes or information of the boundaries of lanes. The second map information 62 may also include road information, traffic regulation information, address information (addresses/postal codes), facility information, parking lot information, telephone number information, or the like. The parking lot information includes, for example, the positions and shapes of parking spaces (parking positions) in which to park vehicles, the number of vehicles that can be parked, the availability of manned traveling, the availability of unmanned traveling, and the like. The second map information 62 may be updated as needed by the communication device 20 communicating with another device.

The driving operators 80 include, for example, an accelerator pedal, a brake pedal, a shift lever, a steering wheel, a different shaped steering member, a joystick, and other operators. Sensors for detecting the amounts of operation or the presence or absence of operation are attached to the driving operators 80. Results of the detection are output to the automated driving control device 100 or some or all of the travel driving force output device 200, the brake device 210, and the steering device 220.

The automated driving control device 100 includes, for example, a first controller 120, a second controller 160, and an HMI controller 180. Each of the first controller 120, the second controller 160, and the HMI controller 180 is realized, for example, by a hardware processor such as a central processing unit (CPU) executing a program (software). Some or all of these components may be realized by hardware (including circuitry) such as large scale integration (LSI), an application specific integrated circuit (ASIC), a field-programmable gate array (FPGA), or a graphics processing unit (GPU) or may be realized by hardware and software in cooperation. The program may be stored in advance in a storage device such as an HDD or a flash memory (a storage device having a non-transitory storage medium) of the automated driving control device 100 or may be stored in a detachable storage medium such as a DVD or a CD-ROM and then installed in the HDD or flash memory of the automated driving control device 100 by mounting the storage medium (the non-transitory storage medium) in a drive device.

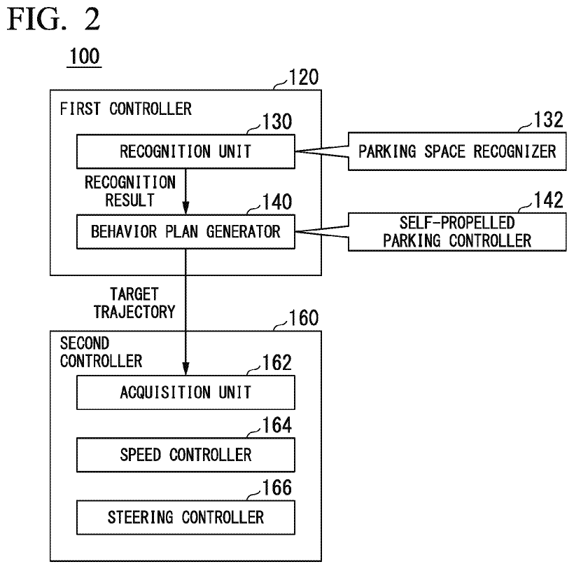

FIG. 2 is a functional configuration diagram of the first controller 120 and the second controller 160. The first controller 120 includes, for example, a recognition unit 130 and a behavior plan generator 140. For example, the first controller 120 realizes a function based on artificial intelligence (AI) and a function based on a previously given model in parallel. For example, a function of “recognizing an intersection” is realized by performing recognition of an intersection through deep learning or the like and recognition based on previously given conditions (presence of a signal, a road sign, or the like for which pattern matching is possible) in parallel and evaluating both comprehensively through scoring. This guarantees the reliability of automated driving.

The recognition unit 130 recognizes states such as the position, speed and acceleration of each object present near the vehicle M on the basis of information input from the camera 10, the radar device 12, and the finder 14 via the object recognition device 16. The position of the object is recognized, for example, as a position in an absolute coordinate system whose origin is at a representative point on the vehicle M (such as the center of gravity or the center of a drive shaft thereof), and used for control. The position of the object may be represented by a representative point on the object such as the center of gravity or a corner thereof or may be represented by an expressed region. The “states” of the object may include an acceleration or jerk of the object or a “behavior state” thereof (for example, whether or not the object is changing or is going to change lanes).

The recognition unit 130 recognizes, for example, a lane in which the vehicle M is traveling (a travel lane). For example, the recognition unit 130 recognizes the travel lane, for example, by comparing a pattern of road lane lines (for example, an arrangement of solid and broken lines) obtained from the second map information 62 with a pattern of road lane lines near the vehicle M recognized from an image captured by the camera 10. The recognition unit 130 may recognize the travel lane by recognizing travel boundaries (road boundaries) including road lane lines, road shoulders, curbs, a median strip, guardrails, or the like, without being limited to road lane lines. This recognition may be performed taking into consideration a position of the vehicle M acquired from the navigation device 50 or a result of processing by the INS. The recognition unit 130 recognizes temporary stop lines, obstacles, red lights, toll gates, entrance and exit gates of a parking lot, and other road phenomena.

When recognizing the travel lane, the recognition unit 130 recognizes the position or attitude of the vehicle M with respect to the travel lane. For example, the recognition unit 130 may recognize both a deviation from the lane center of the reference point of the vehicle M and an angle formed by the travel direction of the vehicle M relative to an extension line of the lane center as the relative position and attitude of the vehicle M with respect to the travel lane. Alternatively, the recognition unit 130 may recognize the position of the reference point of the vehicle M with respect to one of the sides of the travel lane (a road lane line or a road boundary) or the like as the relative position of the vehicle M with respect to the travel lane.

The recognition unit 130 includes a parking space recognizer 132 that is activated in a self-propelled parking event that will be described later. Details of the functions of the parking space recognizer 132 will be described later.

The behavior plan generator 140 generates a target trajectory along which the vehicle M will travel in the future automatically (independently of the driver's operation) such that the vehicle M basically travels in the recommended lane determined by the recommended lane determiner 61 and further copes with situations occurring near the vehicle M. The target trajectory includes, for example, a speed element. The target trajectory is expressed, for example, by an arrangement of points (trajectory points) which are to be reached by the vehicle M in order. The trajectory points are points to be reached by the vehicle M at intervals of a predetermined travel distance (for example, at intervals of about several meters) along the road. Apart from this, a target speed and a target acceleration for each predetermined sampling time (for example, every several tenths of a second) are generated as a part of the target trajectory. The trajectory points may be respective positions at the predetermined sampling times which the vehicle M is to reach at the corresponding sampling times. In this case, information on the target speed or the target acceleration is represented with the interval between the trajectory points.

When generating the target trajectory, the behavior plan generator 140 may set an automated driving event. Examples of the automated driving event include a constant-speed travel event, a low-speed following travel event, a lane change event, a branching event, a merging event, a takeover event, and a self-propelled parking event that is an event of performing parking in a parking lot such as a valet parking lot by automatic traveling. The automatic traveling is performed, for example, by automated driving. Automated driving includes, for example, unmanned traveling. The behavior plan generator 140 generates a target trajectory according to an activated event. The behavior plan generator 140 includes a self-propelled parking controller 142 that is activated when a self-propelled parking event is performed. Details of the functions of the self-propelled parking controller 142 will be described later.

The second controller 160 controls the travel driving force output device 200, the brake device 210, and the steering device 220 such that the vehicle M passes through the target trajectory generated by the behavior plan generator 140 at scheduled times. The second controller 160 includes, for example, an acquisition unit 162, a speed controller 164, and a steering controller 166. The acquisition unit 162 acquires information on the target trajectory (trajectory points) generated by the behavior plan generator 140 and stores it in a memory (not shown). The speed controller 164 controls the travel driving force output device 200 or the brake device 210 on the basis of a speed element pertaining to the target trajectory stored in the memory. The steering controller 166 controls the steering device 220 according to the degree of bending of the target trajectory stored in the memory. The processing of the speed controller 164 and the steering controller 166 is realized, for example, by a combination of feedforward control and feedback control. As an example, the steering controller 166 performs feedforward control according to the curvature of the road ahead of the vehicle M and feedback control based on deviation from the target trajectory in combination.

Returning to FIG. 1, the HMI controller 180 causes the HMI 30 to notify the user of predetermined information. The predetermined information is, for example, information relating to the travel of the vehicle M such as information regarding the state of the vehicle M or information regarding driving control. The information regarding the state of the vehicle M includes, for example, the speed of the vehicle M, the engine speed, and the shift position. The information regarding driving control includes, for example, information on whether or not automated driving is being performed and information on the degree of driving support by automated driving. The predetermined information may also include information not relating to the travel of the vehicle M such as a television show or content (for example, a movie) stored in a storage medium such as a DVD. The HMI controller 180 may output information received through the HMI 30 to the communication device 20, the navigation device 50, the first controller 120, and the like.

The travel driving force output device 200 includes, for example, an engine and an engine electronic control unit (ECU) that controls the engine when the vehicle M is an automobile using an internal combustion engine as a drive power source. The engine ECU adjusts the throttle opening of the engine, the shift stage, and the like according to information input from the second controller 160 or information input from the driving operators 80 and outputs a travel driving force (torque) required for the vehicle M to travel.

The brake device 210 includes, for example, a brake caliper, a cylinder that transmits hydraulic pressure to the brake caliper, an electric motor that generates hydraulic pressure in the cylinder, and a brake ECU. The brake ECU controls the electric motor according to information input from the second controller 160 or information input from the driving operators 80 such that a brake torque corresponding to a braking operation is output to each wheel. The brake device 210 may include, as a backup, a mechanism for transferring a hydraulic pressure generated by an operation of the brake pedal included in the driving operators 80 to the cylinder via a master cylinder. The brake device 210 is not limited to that configured as described above and may be an electronically controlled hydraulic brake device that controls an actuator according to information input from the second controller 160 and transmits the hydraulic pressure of the master cylinder to the cylinder.

The steering device 220 includes, for example, a steering ECU and an electric motor. The electric motor, for example, applies a force to a rack-and-pinion mechanism to change the direction of steering wheels. The steering ECU drives the electric motor according to information input from the second controller 160 or information input from the driving operators 80 to change the direction of the steering wheels.

Next, driving control of the vehicle M in an embodiment will be described in detail. Hereinafter, a situation in which the vehicle M is parked in a valet parking area at a facility to be visited by unmanned traveling will be described as an example of a situation in which driving control of the vehicle M is performed.

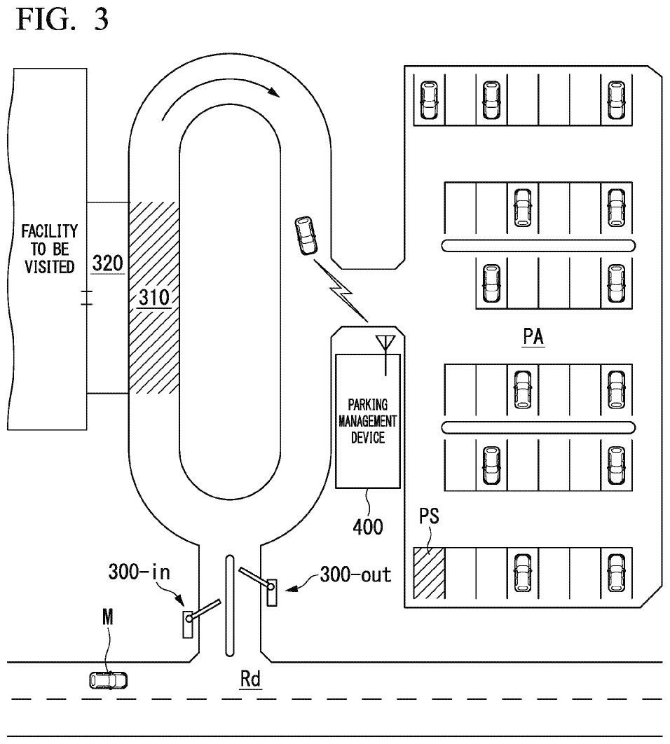

FIG. 3 is a diagram schematically showing a situation in which a self-propelled parking event is performed in an embodiment. A parking area (for example, a valet parking area) PA of the facility to be visited is shown in the example of FIG. 3. The parking area PA is, for example, an area where the vehicle M can be driven or parked by automated driving. It is assumed that the parking area PA is, for example, an area where the vehicle can travel by unmanned traveling and manned traveling and the user of the vehicle M is permitted to pass. The manned traveling includes, for example, traveling by manual driving and traveling by automated driving with the user on board.

For example, gates 300-in and 300-out, a boarding area 310, and a waiting area 320 are provided in the parking area PA on a route from a road Rd to the facility to be visited. In the example of FIG. 3, it is also assumed that a parking management device 400 that manages the parking status of the parking area PA and transmits the empty status and the like to the vehicle M is provided.

Here, processing at the time of vehicle storage and retrieval of the vehicle M by a self-propelled parking event of the self-propelled parking controller 142 will be described.

### [Self-Propelled Parking Event—At the Time of Vehicle Storage]

The self-propelled parking controller 142 causes the vehicle M to be parked in a parking space in the parking area PA, for example, on the basis of information that has been acquired from the parking management device 400 through the communication device 20. In this case, the vehicle M advances to a boarding area 310 through the gate 300-in by manual driving or automated driving. The boarding area 310 faces a waiting area 320 connected to the facility to be visited. An eave for blocking rain and snow may be provided in the waiting area 320.

After letting the user alight in the boarding area 310, the vehicle M starts a self-propelled parking event of performing automated driving to move to a parking space PS in the parking area PA. A start trigger of the self-propelled parking event may be, for example, an operation performed by the user (for example, a vehicle storage instruction from the terminal device 300) or reception of a predetermined signal wirelessly from the parking management device 400. Upon starting the self-propelled parking event, the self-propelled parking controller 142 transmits a parking request to the parking management device 400 by controlling the communication device 20. Then, the vehicle M moves from the boarding area 310 to the parking area PA while following guidance of the parking management device 400 or performing sensing by itself.

### First Embodiment

### [Parking Management Device]

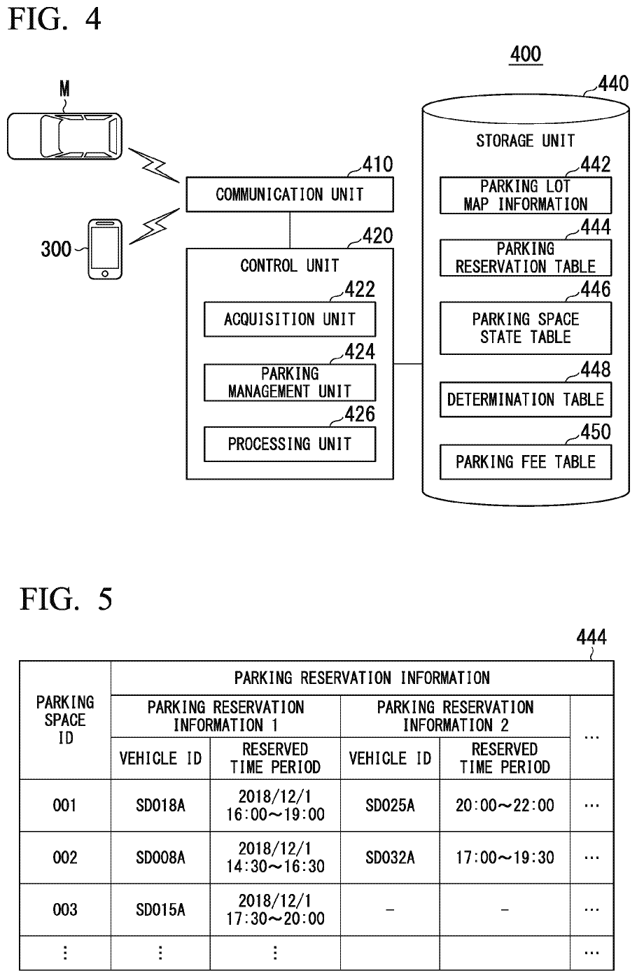

FIG. 4 is a diagram showing an example of the configuration of the parking management device 400 according to a first embodiment. The parking management device 400 includes, for example, a communication unit 410, a control unit 420, and a storage unit 440. The control unit 420 includes, for example, an acquisition unit 422, a parking management unit 424, and a processing unit 426. Each component of the control unit 420 is realized, for example, by a hardware processor such as a CPU executing a program (software). Some or all of these components may be realized by hardware (including circuitry) such as LSI, an ASIC, an FPGA, or a GPU or may be realized by hardware and software in cooperation. The program may be stored in advance in a storage device such as an HDD or a flash memory (a storage device having a non-transitory storage medium) or may be stored in a detachable storage medium such as a DVD or a CD-ROM (a non-transitory storage medium) and then installed by mounting the storage medium in a drive device. The storage unit 440 stores information such as parking lot map information 442, a parking reservation table 444, a parking space state table 446, a determination table 448, and a parking fee table 450. The storage unit 440 is realized by an HDD, a flash memory, or the like.

The communication unit 410 wirelessly communicates with the vehicle M or the terminal device 300 of the user. The control unit 420 guides the vehicle M to the parking space PS on the basis of the information acquired by the communication unit 410 and the information stored in storage unit 440. The parking lot map information 442 is information geometrically representing the structure of the parking area PA. The parking lot map information 442 includes coordinates of each parking space PS.

A reservation for parking of the vehicle M is input to the acquisition unit 422 from the terminal device 300 owned by the user using the communication unit 410. When the reservation for parking of the vehicle M has been input, the acquisition unit 422 acquires, from the terminal device 300, position information of the user of the vehicle M parked in the parking lot, information on a reservation for retrieval of the vehicle M from the parking lot, and information as to whether a request to retrieve the vehicle M from the parking lot has been issued using the communication unit 410 and registers the acquired information in the parking reservation table 444 of the storage unit 440. Information acquired by the acquisition unit 422 includes a reserved time period and a designation of a parking space PS to park in. Information of each record included in the parking reservation table 444 is an example of parking reservation information. A predetermined position in the parking lot may be, for example, the boarding area 310, the parking space of the vehicle M, or another position included in the parking lot.

The parking management unit 424 accepts a request to extend a parking reservation on the basis of information that the acquisition unit 422 has acquired through the communication unit 410 from the terminal device 300 owned by the user and registers the request in the parking reservation table 444.

As shown in FIG. 5, for example, parking reservation information of a vehicle M for the parking lot together with a time period is registered in the parking reservation table 444 for each parking space ID which is identification information of a parking space PS. The parking reservation information is, for example, information in which a vehicle ID which is identification information of a vehicle M to be parked is associated with a reserved time period in which the vehicle M is to be parked. In the present embodiment, the parking reservation information includes a designation of a parking space PS to park in. For example, when a reservation for parking of the vehicle M has been accepted, the vehicle ID is associated with a parking space ID which is identification information of the designated parking space PS.

The parking management unit 424 refers to the parking space state table 446 to manage parking spaces of vehicles M in the parking lot.

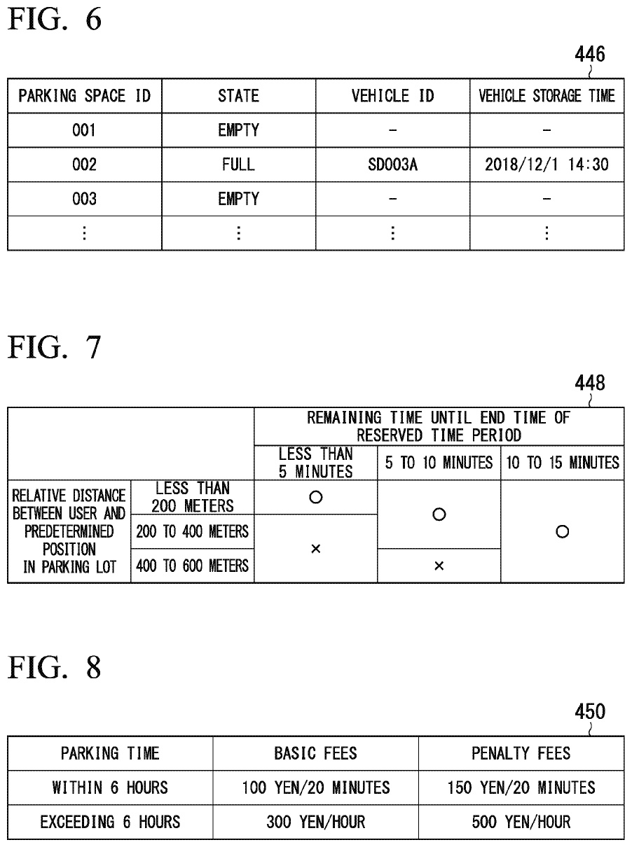

As shown in FIG. 6, the parking space state table 446 is, for example, a table in which each parking space ID which is identification information of a parking space PS is associated with a state indicating whether the parking space is empty or full (parked in), a vehicle ID which is identification information of a vehicle M that has been parked in the parking space if it is full, and a vehicle storage time of the vehicle M if it is full. The vehicle storage time is recorded in association with the vehicle ID when the vehicle M has been stored in the parking lot.

When the communication unit 410 has received a parking request from a vehicle M, the parking management unit 424 refers to the parking reservation table 444 and the parking space state table 446 to extract a parking space (empty space) PS which is empty and will remain empty until a time period for which a reservation has been requested. The parking management unit 424 acquires the position of the extracted parking space PS from the parking lot map information 442 and transmits a suitable route to the acquired position of the parking space PS to the vehicle M using the communication unit 410. Based on the positional relationships of a plurality of vehicles M, the parking management unit 424 instructs a specific vehicle M to stop, slow down or the like as necessary such that vehicles M do not proceed to the same position at the same time.

In the vehicle M that has received the route, the self-propelled parking controller 142 generates a target trajectory based on the route. When approaching the target parking space PS, the parking space recognizer 132 recognizes a parking frame line or the like defining the parking space PS to recognize a detailed position of the parking space PS and provides the recognized detailed position of the parking space PS to the self-propelled parking controller 142. Upon receiving this, the self-propelled parking controller 142 corrects the target trajectory and causes the vehicle M to be parked in the parking space PS.

The self-propelled parking controller 142 is not limited to that described above and may find an empty parking space by itself on the basis of detection results of the camera 10, the radar device 12, the finder 14, or the object recognition device 16 without depending on communication and cause the vehicle M to be parked in the found parking space.

When a new parking reservation has been input through the acquisition unit 422, the processing unit 426 determines whether or not a vehicle M has been parked in a parking space designated by the parking reservation. Upon determining that a vehicle M has been parked in the parking space designated by the parking reservation, the processing unit 426 sets the parked vehicle M as a vehicle of interest. Based on position information of a user of the vehicle of interest acquired by the acquisition unit 422, the processing unit 426 determines whether or not the arrival time at which the user will arrive at a predetermined position in the parking lot exceeds a reserved time period included in the parking reservation information. Next, the processing unit 426 refers to the parking reservation table 444 to determine whether or not a remaining time until an end time of the reserved time period is less than a predetermined threshold for the parking space of the vehicle of interest. The predetermined threshold is set in consideration of the user's travel distance which allows rough determination of the arrival time at which the user will arrive at the predetermined position in the parking lot. Then, when the remaining time until the end time of the reserved time period is less than the predetermined threshold, the processing unit 426 refers to the determination table 448 to determine whether or not the arrival time at which the user of the vehicle of interest will arrive at the predetermined position in the parking lot exceeds the reserved time period included in the parking reservation information.

As shown in FIG. 7, the determination table 448 is, for example, a table in which each combination of a remaining time until the end time of the reserved time period and a relative distance between the user and the predetermined position in the parking lot is associated with whether or not the arrival of the user is possible. The determination table 448 is set such that an allowable range of the relative distance between the user and the predetermined position in the parking lot for determining that the arrival of the user is possible increases as the remaining time until the end time of the reserved time period increases. In this example, the remaining time until the end time of the reserved time period is classified into three stages of “less than 5 minutes,” “5 to 10 minutes,” and “10 to 15 minutes.” The relative distance between the user and the predetermined position in the parking lot is classified into three stages of “less than 200 meters,” “200 to 400 meters,” and “400 to 600 meters.” When the remaining time until the end time of the reserved time period is “less than 5 minutes,” the processing unit 426 determines that the arrival time at which the user will arrive at the predetermined position in the parking lot exceeds the reserved time period included in the parking reservation information if the relative distance between the user and the predetermined position in the parking lot is classified as “200 to 400 meters” or “400 to 600 meters.” When the remaining time until the end time of the reserved time period is “5 to 10 minutes,” the processing unit 426 determines that the arrival time at which the user will arrive at the predetermined position in the parking lot exceeds the reserved time period included in the parking reservation information if the relative distance between the user and the predetermined position in the parking lot is classified as “400 to 600 meters.” When the remaining time until the end time of the reserved time period is “10 to 15 minutes,” the processing unit 426 determines that the arrival time at which the user will arrive at the predetermined position in the parking lot does not exceed the reserved time period included in the parking reservation information no matter whether the relative distance between the user and the predetermined position in the parking lot is classified as “less than 200 meters,” “200 to 400 meters,” or “400 to 600 meters.”

Upon determining that the arrival time at the predetermined position in the parking lot exceeds the reserved time period included in the parking reservation information, the processing unit 426 performs a process for moving the vehicle of interest from the parking space (the parking position). The processing unit 426 performs, for example, a process of transmitting information instructing the movement to the vehicle of interest as a process for moving the vehicle of interest from the parking space. The information instructing the movement may be, for example, information on a suitable route from the current parking space to another parking space, information on control parameters used for steering or acceleration/deceleration control of the vehicle of interest, or a command instructing retrieval of the vehicle of interest from the current parking space. As a process for moving the vehicle of interest from the parking space, the processing unit 426 may check the user's intention before moving the vehicle of interest and move the vehicle of interest upon obtaining consent from the user.

Upon determining that the arrival time at which the user of the vehicle of interest will arrive at the predetermined position in the parking lot exceeds the reserved time period included in the parking reservation information, the processing unit 426 transmits information prompting extension of the reserved time period to the terminal device 300 using the communication unit 410. Then, if the communication unit 410 has received information requesting extension of the reserved time period from the terminal device 300, the processing unit 426 extends the reserved time period registered in the parking reservation table 444. In this case, the processing unit 426 does not move the vehicle of interest from the parking space. On the other hand, if the communication unit 410 has not received information requesting extension of the reserved time period from the terminal device 300, the processing unit 426 moves the vehicle of interest from the parking space and causes the vehicle of interest to automatically travel within the facilities of the parking lot. In the case of moving the vehicle of interest from the parking space and causing the vehicle of interest to automatically travel within the facilities of the parking lot, the processing unit 426 accepts a new parking reservation through the acquisition unit 422.

The processing unit 426 refers to the parking fee table 450 to calculate a parking fee according to the parking time of the vehicle M in the parking lot.

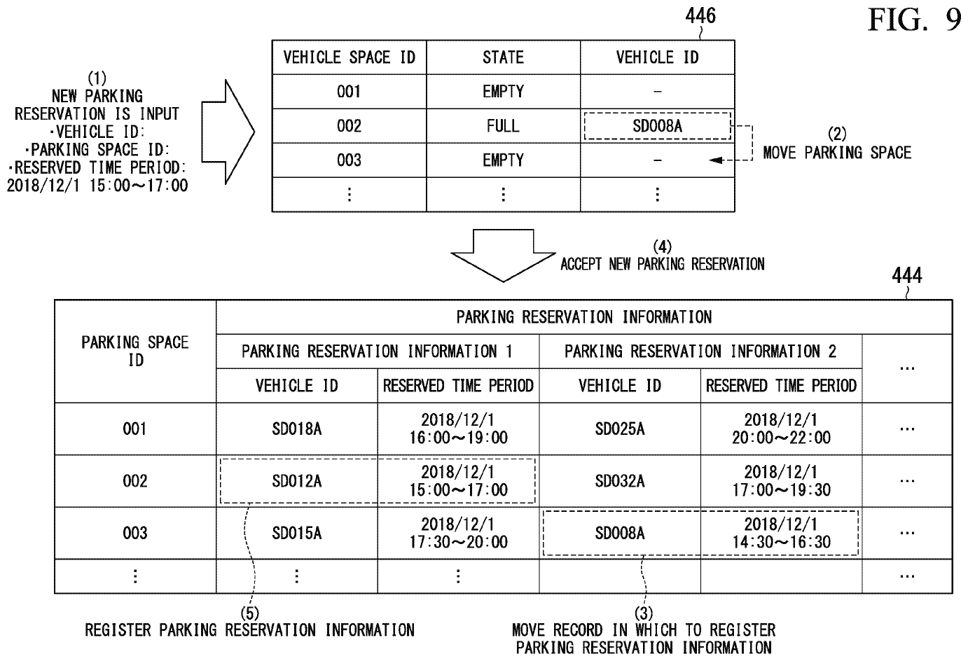

As shown in FIG. 8, the parking fee table 450 is a fee table that defines penalty fees when the parking time of the vehicle M in the parking lot exceeds the reserved time period. The parking fee table 450 is defined such that the parking fee per parking time unit is higher when the reserved time period has not been extended than when the reserved time period has been extended.

Upon determining that the arrival time at which the user will arrive at the predetermined position in the parking lot exceeds the reserved time period included in the parking reservation information when the communication unit 410 has not received information requesting extension of the reserved time period from the terminal device 300, the processing unit 426 calculates the parking fee of the vehicle M by applying a penalty fee that is defined for the case where the reserved time period is exceeded in the parking fee table 450. On the other hand, upon determining that the arrival time at which the user will arrive at the predetermined position in the parking lot exceeds the reserved time period included in the parking reservation information when the communication unit 410 has received information requesting extension of the reserved time period from the terminal device 300, the processing unit 426 does not apply a penalty fee to the time exceeding the reserved time period. Here, the processing unit 426 calculates the parking fee of the vehicle M by applying a basic fee to the parking time including the time exceeding the reserved time period. Then, the processing unit 426 transmits information regarding the parking fee to the terminal device 300 owned by the user through the communication unit 410.

FIG. 9 is a diagram for explaining a flow of processing that the parking management device 400 according to the first embodiment performs when a new parking reservation has been input from a terminal device 300 of a user.

(1) When a new parking reservation has been input, the processing unit 426 designates a parking space corresponding to a parking space ID “002” as a target of the parking reservation. In this example, a vehicle M corresponding to a vehicle ID “SD008A” has been parked in the parking space designated by the processing unit 426. Therefore, the processing unit 426 sets the parked vehicle M as a vehicle of interest. Then, the processing unit 426 performs a process for moving the vehicle of interest from the current parking space. In this example, the processing unit 426 selects a parking space corresponding to a parking space ID “003” that is empty and will remain empty until a time period for which a reservation has been requested and performs a process for moving the vehicle of interest to the selected parking space. (2) Then, upon completing the movement of the vehicle of interest to the selected parking space, the processing unit 426 updates registration information of the parking space state table 446 such that the vehicle ID “SD008A” of the moved vehicle of interest is associated with the parking space ID “003” corresponding to the selected parking space. (3) The processing unit 426 moves a record in the parking space state table 446, in which to register parking reservation information including the vehicle ID “SD008A” of the moved vehicle of interest, such that the parking reservation information including the vehicle ID “SD008A” of the moved vehicle of interest is associated with the parking space ID “003” corresponding to the selected parking space.

(4) Next, the processing unit 426 accepts a new parking reservation for the parking space corresponding to the parking space ID “002” that has become empty due to the movement of the vehicle of interest. (5) Then, the processing unit 426 registers parking reservation information regarding the new parking reservation in the parking reservation table 444 such that the parking reservation information regarding the new parking reservation is associated with the parking space ID “002” corresponding to the parking space for which the new parking reservation has been accepted.

### [Process Flow]

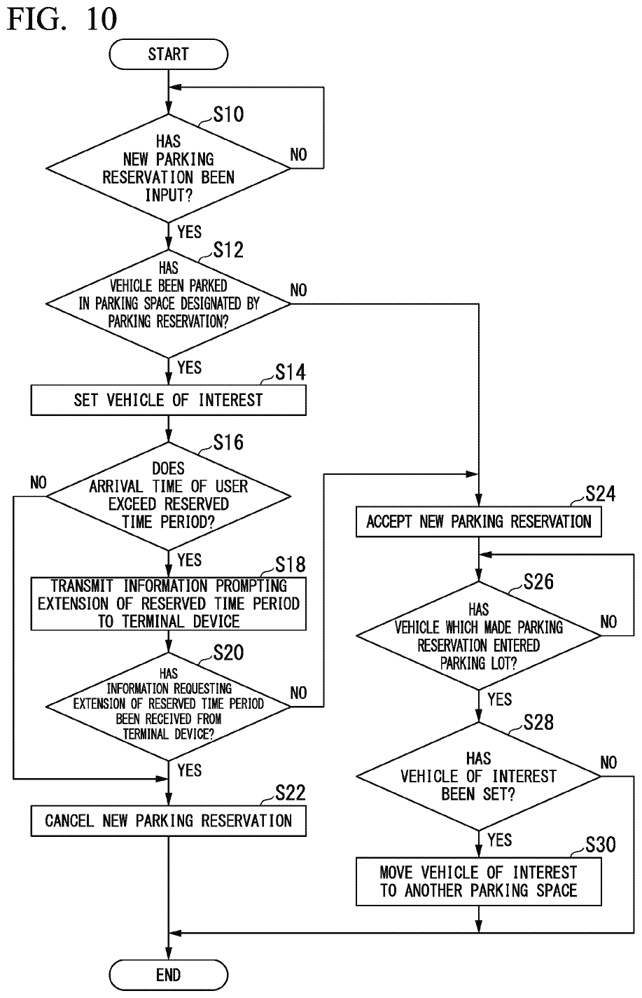

Hereinafter, a flow of a series of processes of the parking management device 400 according to the first embodiment will be described with reference to a flowchart. FIG. 10 is a flowchart showing a flow of a series of processes of the parking management device 400 according to the first embodiment. The process of this flowchart may be repeatedly performed at predetermined periods.

First, the processing unit 426 determines whether or not a new parking reservation has been input from a terminal device 300 owned by a user through the acquisition unit 422 (step S10). Next, upon determining that a new parking reservation has been input, the processing unit 426 refers to the parking space state table 446 to determine whether or not a vehicle M has been parked in a parking space designated by the parking reservation (step S12). Next, upon determining that a vehicle M has been parked, the processing unit 426 sets the parked vehicle M as a vehicle of interest (step S14).

Next, the processing unit 426 refers to the determination table 448 to determine whether or not the arrival time of a user of the vehicle of interest exceeds a reserved time period included in the parking reservation information (step S16). Upon determining that the arrival time of the user exceeds the reserved time period included in the parking reservation information, the processing unit 426 transmits information prompting extension of the reserved time period to a terminal device 300 owned by the user (step S18). Next, the processing unit 426 determines whether or not information requesting extension of the reserved time period has been received from the terminal device 300 (step S20). Upon determining that information requesting extension of the reserved time period has been received from the terminal device 300, the processing unit 426 cancels the new parking reservation (step S22). Upon determining that the arrival time of the user does not exceed the reserved time period included in the parking reservation information, the processing unit 426 also cancels the new parking reservation (step S22). Then, the process of this flowchart ends.

On the other hand, upon determining that information requesting extension of the reserved time period has not been received from the terminal device 300, the processing unit 426 accepts the new parking reservation (step S24). Upon determining that no vehicle M has been parked in the parking space designated by the new parking reservation, the processing unit 426 also accepts the new parking reservation (step S24). Upon accepting the new parking reservation, the processing unit 426 determines whether or not a vehicle M that has made the parking reservation has entered the parking lot (step S26). Upon determining that the vehicle M that has made the parking reservation has entered the parking lot, the processing unit 426 determines whether or not the vehicle of interest has been set in step S14 above (step S28). Upon determining that the vehicle of interest has been set, the processing unit 426 selects a parking space to which the vehicle of interest is to be moved and moves the vehicle of interest to the selected parking space (step S30). Then, the process of this flowchart ends. On the other hand, upon determining that the vehicle of interest has not been set, the processing unit 426 ends the process of this flowchart without performing the process of step S30.

The parking management device 400 according to the first embodiment described above can manage parking times of vehicles M as scheduled. For example, even when the arrival time at which the user will arrive at the predetermined position in the parking lot exceeds the reserved time period included in the parking reservation information, a new reservation for parking in the parking space of the vehicle M cannot be accepted until the vehicle M is retrieved. On the other hand, the parking management device 400 according to the first embodiment performs a process for moving the vehicle M from the current parking space if a new parking reservation is input when the arrival time at which the user will arrive at the predetermined position in the parking lot exceeds the reserved time period included in the parking reservation information. Therefore, the parking times of vehicles M can be managed as scheduled.

In addition, the parking management device 400 according to the first embodiment can improve convenience when users use the parking lot. For example, performing a process for moving the vehicle M from the current parking space even though the reserved time period included in the parking reservation information has been extended impairs convenience when the user of the parked vehicle M uses the parking lot. On the other hand, even when the arrival time at which the user will arrive at the predetermined position in the parking lot exceeds the reserved time period included in the parking reservation information, the parking management device 400 according to the first embodiment does not move the parked vehicle M if the reserved time period included in the parking reservation information is extended. Therefore, convenience when users use the parking lot can be improved.

### Second Embodiment

Hereinafter, a second embodiment will be described. The second embodiment differs from the first embodiment in that parking reservation information does not include a designation of a parking space PS. The difference will be mainly described below.

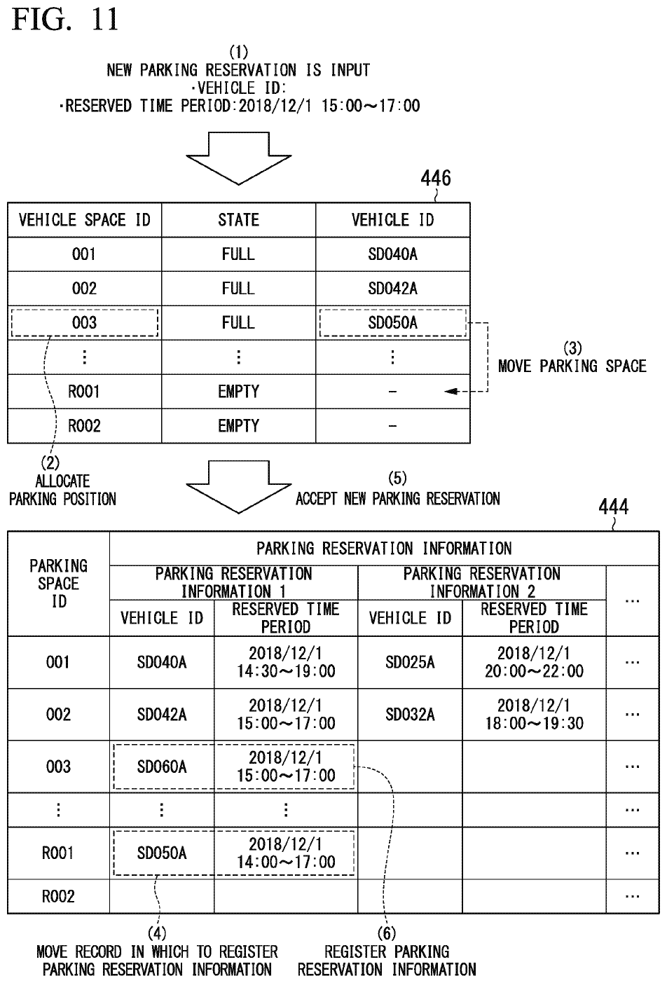

FIG. 11 is a diagram for explaining a flow of processing that the parking management device 400 according to the second embodiment performs when a new parking reservation has been input from a terminal device 300 of a user.

(1) When a new parking reservation has been input, the processing unit 426 refers to the parking space state table 446 to check the parking status of the parking lot. (2) Next, the processing unit 426 allocates a parking space corresponding to a parking space ID “003” as a parking space of a vehicle M that has made the parking reservation. The processing unit 426 performs a process for moving a vehicle M corresponding to a vehicle ID “SD050A,” which has been parked in the allocated parking space, from this current parking space. When all parking spaces except spare parking spaces are full, the processing unit 426 selects a parking space corresponding to a parking space ID “R001” that is empty and will remain empty until a time period for which a reservation has been requested from the spare parking spaces and performs a process for moving the vehicle M to the selected parking space. (3) Then, upon completing the movement of the vehicle M to the selected parking space, the processing unit 426 moves a record in the parking space state table 446, in which to register parking reservation information including the vehicle ID “SD050A” of the moved vehicle M, such that the parking reservation information including the vehicle ID “SD050A” of the moved vehicle M is associated with the parking space ID “R001” corresponding to the selected parking space. (4) The processing unit 426 registers the parking reservation information including the vehicle ID “SD050A” of the moved vehicle M in the parking reservation table 444 such that the parking reservation information including the vehicle ID “SD050A” of the moved vehicle M is associated with the parking space ID “R001” corresponding to the selected parking space.

(5) Next, the processing unit 426 accepts a new reservation for parking in the parking space corresponding to the parking space ID “003” that has become empty due to the movement of the vehicle M. (6) Then, the processing unit 426 registers parking reservation information regarding the new parking reservation in the parking reservation table 444 such that the parking reservation information regarding the new parking reservation is associated with the parking space ID “003” corresponding to the parking space for which the new parking reservation has been accepted.

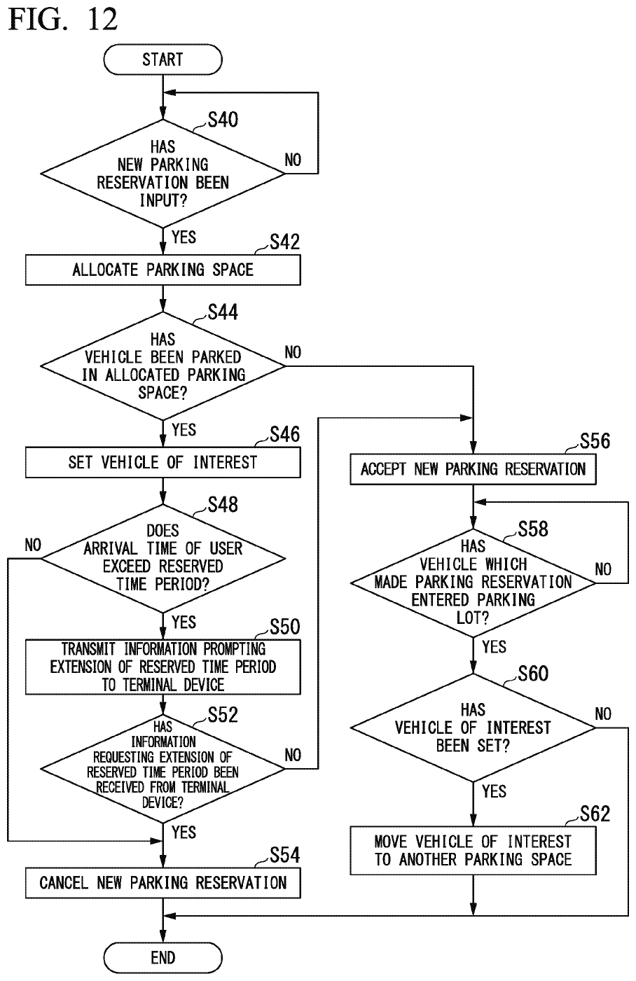

Hereinafter, a flow of a series of processes of the parking management device 400 according to the second embodiment will be described with reference to a flowchart. FIG. 12 is a flowchart for explaining a flow of a series of processes of the parking management device 400 according to the second embodiment. The process of this flowchart may be repeatedly performed, for example, at predetermined periods.

First, the processing unit 426 determines whether or not a new parking reservation has been input from a terminal device 300 owned by a user through the acquisition unit 422 (step S40). Next, upon determining that a new parking reservation has been input, the processing unit 426 allocates a parking space for a vehicle M that has made the parking reservation (step S42). When all parking spaces except spare parking spaces are full, the processing unit 426 allocates a spare parking space as a parking space for the vehicle M that has made the parking reservation. Next, the processing unit 426 determines whether or not a vehicle M has been parked in the allocated parking space (step S44). Then, upon determining that a vehicle M has been parked in the allocated parking space, the processing unit 426 sets the parked vehicle M as a vehicle of interest (step S46).

Next, the processing unit 426 refers to the determination table 448 to determine whether or not the arrival time of a user of the vehicle of interest exceeds a reserved time period included in the parking reservation information (step S48). Upon determining that the arrival time of the user exceeds the reserved time period included in the parking reservation information, the processing unit 426 transmits information prompting extension of the reserved time period to a terminal device 300 owned by the user (step S50). The processing unit 426 determines whether or not information requesting extension of the reserved time period has been received from the terminal device 300 (step S52). Upon determining that information requesting extension of the reserved time period has been received from the terminal device 300, the processing unit 426 cancels the new parking reservation (step S54). When the arrival time of the user does not exceed the reserved time period included in the parking reservation information, the processing unit 426 also cancels the new parking reservation (step S54). Then, the process of this flowchart ends.

On the other hand, upon determining that information requesting extension of the reserved time period has not been received from the terminal device 300, the processing unit 426 accepts the new parking reservation (step S56). Upon determining that no vehicle M has been parked in the allocated parking space, the processing unit 426 also accepts the new parking reservation (step S56). Upon accepting the new parking reservation, the processing unit 426 determines whether or not a vehicle M that has made the parking reservation has entered the parking lot (step S58). Upon determining that the vehicle M that has made the parking reservation has entered the parking lot, the processing unit 426 determines whether or not the vehicle of interest has been set in step S46 above (step S60). Upon determining that the vehicle of interest has been set, the processing unit 426 selects a parking space to which the vehicle of interest is to be moved and moves the vehicle of interest to the selected parking space (step S62). Then, the process of this flowchart ends. On the other hand, upon determining that the vehicle of interest has not been set, the processing unit 426 ends the process of this flowchart without performing the process of step S62.

The parking management device 400 according to the second embodiment described above can manage parking times of vehicles M as scheduled, similar to the parking management device 400 according to the first embodiment. In addition, the parking management device 400 according to the second embodiment can improve convenience when users use the parking lot, similar to the parking management device 400 according to the first embodiment.

### Third Embodiment

Hereinafter, a third embodiment will be described. The third embodiment differs from the first embodiment in that a process for moving a vehicle from a parking space is performed regardless of whether or not a new parking reservation has been input. The difference will be mainly described below.

Upon determining that the arrival time at which the user of the vehicle M will arrive at the predetermined position in the parking lot exceeds the reserved time period included in the parking reservation information, the processing unit 426 transmits information prompting extension of the reserved time period to the terminal device 300 using the communication unit 410. Then, if there is no parking reservation for a time period subsequent to the reserved time period when the communication unit 410 has received information requesting extension of the reserved time period from the terminal device 300, the processing unit 426 does not move the vehicle M parked in the parking lot from the parking space. Also, if there is no parking reservation for a time period subsequent to the reserved time period when the communication unit 410 has received information requesting extension of the reserved time period from terminal device 300, the processing unit 426 does not apply a penalty fee for the time exceeding the reserved time period. Here, the processing unit 426 calculates the parking fee of the vehicle M by applying a basic fee to the parking time including the time exceeding the reserved time period. On the other hand, if there is no parking reservation for a time period subsequent to the reserved time period when the communication unit 410 has not received information requesting extension of the reserved time period from the terminal device 300, the processing unit 426 calculates the parking fee of the vehicle M by applying a penalty fee that is defined for the case where the reserved time period is exceeded in the parking fee table 450.

The processing unit 426 moves the vehicle M from the parking space if there is a parking reservation for a time period subsequent to the reserved time period when the communication unit 410 has not received information requesting extension of the reserved time period from the terminal device 300. In this case, the processing unit 426 moves the vehicle M parked in the parking lot from the parking space when a vehicle M that has made the parking reservation has entered the parking lot.

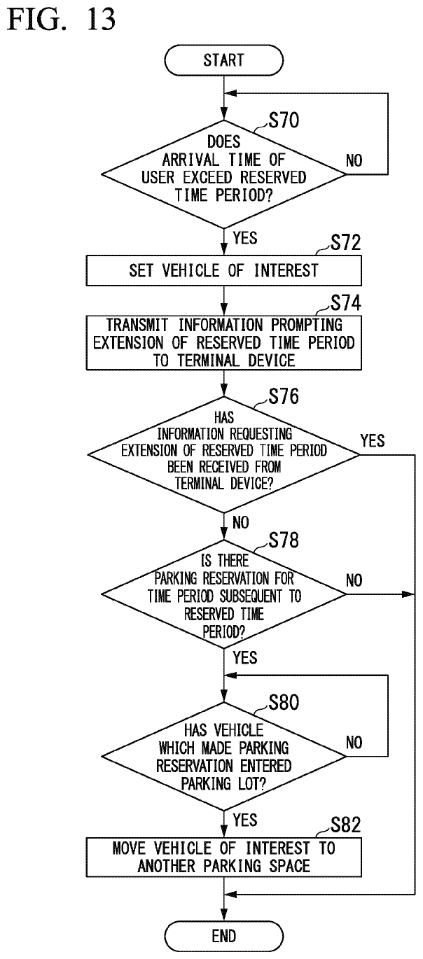

Hereinafter, a flow of a series of processes of the parking management device 400 according to the third embodiment will be described with reference to a flowchart. FIG. 13 is a flowchart for explaining a flow of a series of processes of the parking management device 400 according to the third embodiment. The process of this flowchart may be repeatedly performed, for example, at predetermined periods.

First, the processing unit 426 refers to the determination table 448 to determine whether or not the arrival time of a user of a vehicle M exceeds a reserved time period included in the parking reservation information (step S70). Upon determining that the arrival time of the user exceeds the reserved time period included in the parking reservation information, the processing unit 426 sets the vehicle M of the user as a vehicle of interest (S72). Then, the processing unit 426 transmits information prompting extension of the reserved time period to a terminal device 300 owned by the user (step S74). The processing unit 426 determines whether or not the communication unit 410 has received information requesting extension of the reserved time period from the terminal device 300 (step S76). Upon determining that the communication unit 410 has received information requesting extension of the reserved time period from the terminal device 300, the processing unit 426 does not move the vehicle of interest from the parking space. Then, the process of this flowchart ends. On the other hand, upon determining that the communication unit 410 has not received information requesting extension of the reserved time period from the terminal device 300, the processing unit 426 refers to the parking reservation table 444 to determine whether or not there is a parking reservation for a time period subsequent to the reserved time period (step S78). Upon determining that there is a parking reservation for a time period subsequent to the reserved time period, the processing unit 426 determines whether or not a vehicle M that has made the parking reservation has entered the parking lot (step S80). Upon determining that the vehicle M that has made the parking reservation has entered the parking lot, the processing unit 426 selects a parking space to which the vehicle of interest is to be moved and moves the vehicle of interest to the selected parking space (step S82). Then, the process of this flowchart ends. On the other hand, upon determining that there is no parking reservation for a time period subsequent to the reserved time period, the processing unit 426 does not move the vehicle of interest from the parking space. Then, the process of this flowchart ends.

The parking management device 400 according to the third embodiment described above can manage parking times of vehicles M as scheduled. For example, even if a parking reservation has been registered for a time period subsequent to the reserved time period when the arrival time at which the user will arrive at the predetermined position in the parking lot exceeds the reserved time period included in the parking reservation information, it is not possible to park the vehicle M which has made the parking reservation in the parking space until the vehicle M is retrieved. On the other hand, if a parking reservation has been registered for a time period subsequent to the reserved time period when the arrival time at which the user will arrive at the predetermined position in the parking lot exceeds the reserved time period included in the parking reservation information, the parking management device 400 according to the third embodiment performs a process for moving the vehicle M from the current parking space unless a request to extend the reserved time period is issued. Therefore, the parking times of vehicles M can be managed as scheduled.

### Fourth Embodiment

Hereinafter, a fourth embodiment will be described. The fourth embodiment differs from the first embodiment in that an information processing device is mounted on a vehicle. The difference will be mainly described below.

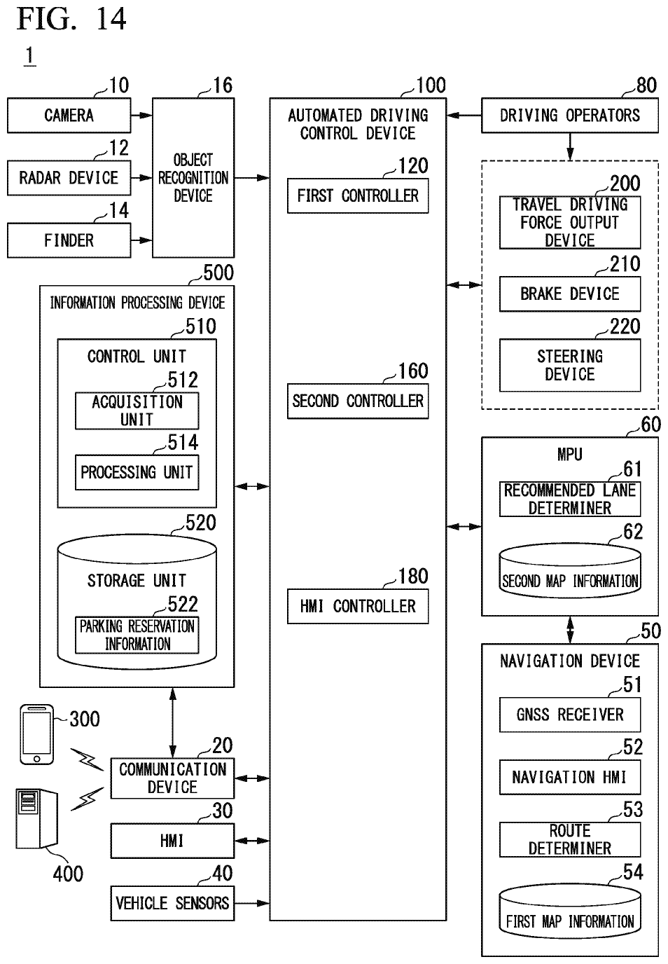

FIG. 14 is a configuration diagram of a vehicle system 1 according to the fourth embodiment. The vehicle system 1 includes, for example, a camera 10, a radar device 12, a finder 14, an object recognition device 16, a communication device 20, a human machine interface (HMI) 30, vehicle sensors 40, a navigation device 50, a map positioning unit (MPU) 60, driving operators 80, an automated driving control device 100, a travel driving force output device 200, a brake device 210, a steering device 220, and an information processing device 500. These devices or apparatuses are connected to each other by a multiplex communication line or a serial communication line such as a controller area network (CAN) communication line, a wireless communication network, or the like. The components shown in FIG. 14 are merely an example and some of the components may be omitted or other components may be added. In the present embodiment, the communication device 20 communicates with a terminal device 300 owned by the user in addition to other vehicles present near the vehicle M, the parking management device 400, or various server devices.

The information processing device 500 includes, for example, a control unit 510 and a storage unit 520. The control unit 510 includes, for example, an acquisition unit 512 and a processing unit 514. Each component of the control unit 510 is realized, for example, by a hardware processor such as a CPU executing a program (software). Some or all of these components may be realized by hardware (including circuitry) such as LSI, an ASIC, an FPGA, or a GPU or may be realized by hardware and software in cooperation. The program may be stored in advance in a storage device such as an

HDD or a flash memory (a storage device having a non-transitory storage medium) or may be stored in a detachable storage medium such as a DVD or a CD-ROM (a non-transitory storage medium) and then installed by mounting the storage medium in a drive device. The storage unit 520 stores information such as parking reservation information 522. The storage unit 520 is realized by an HDD, a flash memory, or the like.

A reservation for parking of the vehicle M is input to the acquisition unit 512 from the terminal device 300 owned by the user using the communication device 20. When the reservation for parking of the vehicle M has been input, the acquisition unit 512 acquires, from the terminal device 300 owned by the user or the parking management device 400, position information of the user, information on a reservation for retrieval of the vehicle M from the parking lot, and information as to whether a request to retrieve the vehicle M from the parking lot has been issued using the communication device 20. The acquisition unit 512 also stores the information on the reservation for retrieval of the vehicle M from the parking lot among the acquired information in the storage unit 520 as parking reservation information 522.

The processing unit 514 refers to the position information of the user acquired by the acquisition unit 512 and the parking reservation information 522 stored in the storage unit 520 to determine whether or not a remaining time until the end time of the reserved time period is less than a predetermined threshold. Upon determining that the remaining time until the end time of the reserved time period is less than the predetermined threshold, the processing unit 514 sets the vehicle M as a vehicle of interest. Based on the position information of the user of the vehicle of interest, the processing unit 514 refers to the parking reservation information 522 to determine whether or not the arrival time at which the user of the vehicle of interest will arrive at the predetermined position in the parking lot exceeds the reserved time period included in the parking reservation information. Then, upon determining that the arrival time at the predetermined position in the parking lot exceeds the reserved time period included in the parking reservation information, the processing unit 514 performs a process for moving the vehicle of interest from the parking space. The processing unit 514 performs, for example, a process of causing the vehicle of interest to automatically travel as a process for moving the vehicle of interest from the parking space.

The processing unit 514 refers to the parking fee table 450 managed by the parking management device 400 to calculate a parking fee according to the parking time of the vehicle M in the parking lot. The processing unit 514 notifies the user of information regarding the parking fee through the HMI 30. The processing unit 514 may also transmit information regarding the parking fee to the terminal device 300 owned by the user through the communication device 20.

The information processing device 500 according to the fourth embodiment described above can manage parking times of vehicles M as scheduled, similar to the parking management device 400 according to the first embodiment. In addition, the information processing device 500 according to the fourth embodiment can improve convenience when users use the parking lot, similar to the parking management device 400 according to the first embodiment.

### [Hardware Configuration]

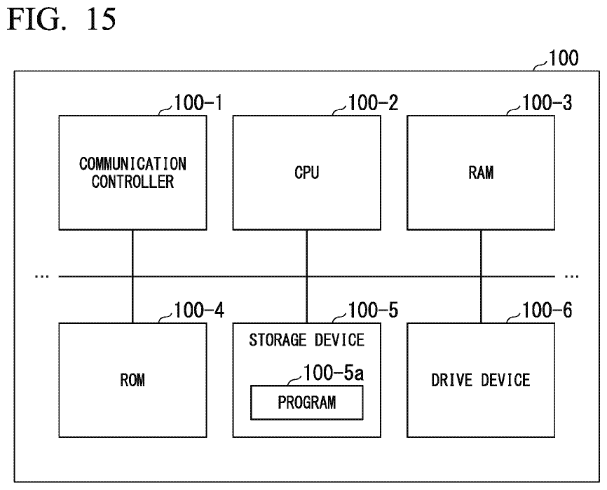

FIG. 15 is a diagram showing an example of the hardware configuration of the automated driving control device 100. As shown, the automated driving control device 100 is configured such that a communication controller 100-1, a CPU 100-2, a RAM 100-3 used as a working memory, a ROM 100-4 storing a boot program or the like, a storage device 100-5 such as a flash memory or an HDD, a drive device 100-6, or the like are connected to each other via an internal bus or a dedicated communication line. The communication controller 100-1 performs communication with components other than the automated driving control device 100. A portable storage medium such as an optical disc (for example, a non-transitory computer-readable storage medium) is mounted in the drive device 100-6. The storage device 100-5 stores a program 100-5a to be executed by the CPU 100-2. This program is loaded in the RAM 100-3 by a direct memory access (DMA) controller (not shown) or the like and then executed by the CPU 100-2. The program 100-5a referred to by the CPU 100-2 may be stored in a portable storage medium mounted in the drive device 100-6 or may be downloaded from another device via a network. Thereby, some or all of the functions of the automated driving control device 100 are realized.

In each of the above embodiments, information instructing the vehicle M to move may be, for example, an electronic key for starting a driving operation of the vehicle M. In this case, delivery of the electronic key may be performed, for example, by transmitting the electronic key from the parking management device 400 to the vehicle M through wireless communication or by storing the electronic key of the vehicle M in a detachable storage medium such as a DVD or a CD-ROM. In this case, a manager of the parking lot carries the storage medium to the vehicle M and attaches the storage medium to a reading device mounted on the vehicle M such that the vehicle M acquires the electronic key from the storage medium, thereby permitting unlocking and start of driving of the vehicle M. The manager of the parking lot manually moves the vehicle M from the current parking space. Note that the processing unit 426 sets an upper limit of the number of vehicles which are collaterally moved from the parking space and changes the upper limit on the basis of information acquired from the terminal device 300 owned by the user.

Further, in each of the above embodiments, the processing unit 426 may receive an operation of driving the vehicle M performed by the manager of the parking lot when the communication unit 410 has not received information requesting extension of the reserved time period from the terminal device 300. In this case, the processing unit 426 moves the vehicle M to a parking space designated by the manager of the parking lot, on condition that the operation of driving the vehicle M performed by the manager of the parking lot has been received.

Although the modes for carrying out the present invention have been described above by way of embodiments, the present invention is not limited to these embodiments at all and various modifications and substitutions can be made without departing from the gist of the present invention.

What is claimed is:

1. An information processing device comprising:
an acquisition unit configured to acquire position information of a user of a vehicle parked in a parking lot; and
a processing unit configured to determine whether or not an arrival time of the user at a predetermined position in the parking lot exceeds a reserved time period included in parking reservation information on the basis of the position information of the user, determine whether or not to move the vehicle from a parking position on the basis of a result of the determination as to whether the arrival time exceeds the reserved time period, and perform processing based on a result of the determination as to whether to move the vehicle.

2. The information processing device according to claim 1, further comprising a communication unit configured to communicate with a terminal device of the user,
wherein the processing unit is configured to transmit information prompting extension of the reserved time period to the terminal device using the communication unit upon determining that the arrival time of the user at the predetermined position in the parking lot exceeds the reserved time period included in the parking reservation information and not to move the vehicle from the parking position when the communication unit has received information requesting extension of the reserved time period from the terminal device.

3. The information processing device according to claim 1, further comprising a communication unit configured to communicate with a terminal device of the user,
wherein the processing unit is configured to transmit information prompting extension of the reserved time period to the terminal device using the communication unit upon determining that the arrival time of the user at the predetermined position in the parking lot exceeds the reserved time period included in the parking reservation information and move the vehicle from the parking position when the communication unit has not received information requesting extension of the reserved time period from the terminal device.

4. The information processing device according to claim 3, wherein the processing unit is configured to receive an operation of driving the vehicle performed by a manager of the parking lot when the communication unit has not received information requesting extension of the reserved time period from the terminal device.

5. The information processing device according to claim 2, wherein the processing unit is configured not to move the vehicle from the parking position if there is no parking reservation for a time period subsequent to the reserved time period when the communication unit has not received information requesting extension of the reserved time period from the terminal device.

6. The information processing device according to claim 5, wherein the processing unit is configured to calculate a parking fee of the vehicle by applying a penalty fee that is defined for a case where the reserved time period is exceeded in a parking fee table if there is no parking reservation for a time period subsequent to the reserved time period when the communication unit has not received information requesting extension of the reserved time period from the terminal device.

7. The information processing device according to claim 6, wherein the parking fee table is defined such that a parking fee per parking time unit is higher when the reserved time period has not been extended than when the reserved time period has been extended.

8. The information processing device according to claim 2, wherein the processing unit is configured to move the vehicle from the parking position if there is a parking reservation for a time period subsequent to the reserved time period when the communication unit has not received information requesting extension of the reserved time period from the terminal device.

9. The information processing device according to claim 8, wherein the processing unit is configured to, if there is a parking reservation for a time period subsequent to the reserved time period when the communication unit has not received information requesting extension of the reserved time period from the terminal device, move the vehicle parked in the parking lot from the parking position when a vehicle that has made the parking reservation has entered the parking lot.

10. The information processing device according to claim 1, wherein the processing unit is configured to set an upper limit of the number of vehicles which are collaterally moved from the parking position and change the upper limit on the basis of information acquired from the terminal device of the user.

11. The information processing device according to claim 1, wherein the information processing device is configured to function as a parking management device and perform a process of transmitting information instructing movement to the vehicle as a process of moving the vehicle from the parking position.

12. The information processing device according to claim 1, wherein the information processing device is mounted in a vehicle and configured to perform a process of causing the vehicle to automatically travel as a process of moving the vehicle from the parking position.

13. An information processing method comprising:
acquiring by a computer, position information of a user of a vehicle parked in a parking lot; and
determining by the computer, whether or not an arrival time of the user at a predetermined position in the parking lot exceeds a reserved time period included in parking reservation information on the basis of the position information of the user, determining whether or not to move the vehicle from a parking position on the basis of a result of the determination as to whether the arrival time exceeds the reserved time period, and performing processing based on a result of the determination as to whether to move the vehicle.

14. A non-transitory computer-readable storage medium that stores a program causing a computer to execute:
a process of acquiring position information of a user of a vehicle parked in a parking lot; and
a process of determining whether or not an arrival time of the user at a predetermined position in the parking lot exceeds a reserved time period included in parking reservation information on the basis of the position information of the user, determining whether or not to move the vehicle from a parking position on the basis of a result of the determination as to whether the arrival time exceeds the reserved time period, and performing processing based on a result of the determination as to whether to move the vehicle.
